(19) United States
(12) Patent Application Publication
(10) Pub. No.: US 2020/0031180 A1
(43) Pub. Date: Jan. 30, 2020

(54) MONITORING DEVICE, TIRE AIR PRESSURE MONITORING SYSTEM, AND CONTROL PROGRAM

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Akinori Usami, Yokkaichi, Mie (JP)

(21) Appl. No.: 16/491,630

(22) PCT Filed: Feb. 19, 2018
(86) PCT No.: PCT/JP2018/005764

§ 371 Date: Sep. 6, 2019

(30) Foreign Application Priority Data
Mar. 9, 2017 (JP) 2017-045261

(51) Int. Cl. B60C 23/04

(52) U.S. Cl. CPC B60C 23/0474; B60C 23/0401

(57) ABSTRACT

A monitoring device comprises an acquisition unit configured to acquire information related to movement or stoppage of the vehicle; a request signal transmission unit configured to wirelessly transmit the request signal to the detection device if it is determined that the vehicle is stopped based on the information acquired by the acquisition unit; an air pressure signal reception unit configured to receive the air pressure signal that is transmitted from the detection device in response to the request signal; and an output unit configured to, in a case where the request signal transmission unit transmitted the request signal, outputs a warning signal for giving a warning inside the vehicle, if the air pressure signal in response to the request signal is not received by the air pressure signal reception unit.

### CROSS-REFERENCE TO RELATED APPLICATIONS

This application is the U.S. national stage of PCT/JP2018/005764 filed on Feb. 19, 2018, which claims priority of Japanese Patent Application No. JP 2017-045261 filed on Mar. 9, 2017, the contents of which are incorporated herein.

### TECHNICAL FIELD

The present disclosure relates to a monitoring device, a tire air pressure monitoring system, and a control program.

### BACKGROUND

There are tire air pressure monitoring systems (TPMS: Tire Pressure Monitoring System) that detect the air pressures of the tires of a vehicle and give warnings or the like to users if a detected air pressure is abnormal (for example, JP 2015-20481A). The tire air pressure monitoring systems include detection devices that are provided in the tires and monitoring devices that are arranged in the vehicle body. The detection devices detect the air pressures of the tires to obtain air pressure signals that are wirelessly transmitted over UHF radio waves. The monitoring devices receive the air pressure signals that have been transmitted from the detection devices and monitor the air pressures of the tires based on the received air pressure signals. If there is a tire with abnormal air pressure, the monitoring devices give warnings by indicating on indicators that there is a tire with abnormal air pressure.

In the tire air pressure monitoring systems, there are two communication systems, namely a unidirectional system in which the detection devices transmit air pressure signals autonomously, and a bidirectional system in which the detection devices transmit air pressure signals in response to requests from the monitoring devices. The bidirectional system is suitable when the vehicle is stopped. The monitoring devices with the bidirectional system use LF radio waves to transmit request signals to the detection devices to request information about air pressure from LF transmission antennas that are provided in the periphery of the wheel wells. The detection devices that have received the request signals then transmit the detected air pressure signals to the monitoring devices.

For a variety of reasons, the request signal may not reach the detection device depending the positional relationship between the monitoring device and the detection device, that is, the rotational angle of the tire. The range of rotational angles at which the request signal will not reach the detection device is merely a small number of degrees, but if the vehicle stops in a state in which the detection device enters this range of rotational angles, then the air pressure of the tires cannot be monitored after the vehicle is stopped and before the vehicle starts to move, even if the bidirectional system is used. Hereinafter, the range of rotational angles at which the request signal will not reach the detection device shall be referred to as an incommunicable area.

Note that JP 2015-20481A discloses a technique to detect the rotational position of a tire and direct the vehicle to stop in a position in which the rotational position of the tire does not hinder communication between the monitoring device and the detection devices, but this technique relates to a monitoring device that uses a unidirectional system. Also, in JP 2015-20481A, the monitoring device stores the rotational position of the wheels when the air pressure signals that have been transmitted from the detection devices are received, estimates the region in which signal strength is insufficient for receiving the air pressure signals that have been transmitted from the detection devices, with this estimation being based on the current rotational position of the tires at that time and the rotational position when the vehicle moves very slowly, and thus cannot accurately detect positions in which the vehicle stops that result in bidirectional communication becoming impossible.

### SUMMARY

An object of the present disclosure is to provide a monitoring device, a tire air pressure monitoring system, and a control program that can output a warning signal when a vehicle is stopped in a position in which bidirectional communication becomes impossible, in order to be able to monitor the tire air pressure before the vehicle starts to move again.

A monitoring device according to an aspect of the present disclosure transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal, and monitors the air pressure of the tire, the monitoring device comprising: an acquisition unit configured to acquire information related to movement or stoppage of the vehicle; a request signal transmission unit configured to wirelessly transmit the request signal to the detection device if it is determined that the vehicle is stopped based on the information acquired by the acquisition unit; an air pressure signal reception unit configured to receive the air pressure signal that is transmitted from the detection device in response to the request signal; and an output unit configured to, in a case where the request signal transmission unit transmitted the request signal, outputs a warning signal for giving a warning inside the vehicle, if the air pressure signal in response to the request signal is not received by the air pressure signal reception unit.

A control program according to an aspect the present disclosure causes a control unit of a monitoring device that transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal and monitors the air pressure of the tire to: acquire information related to movement or stoppage of the vehicle; wirelessly transmit the request signal to the detection device if it is determined that the vehicle is stopped based on the acquired information; receive the air pressure signal that is transmitted from the detection device in response to the request signal; and in a case where the monitoring device transmitted the request signal, output a warning signal for giving a warning inside of the vehicle, when the air pressure signal in response to the request signal is not received by the monitoring device.

Note that the disclosure of the present application can not only be realized as a monitoring device and a tire air pressure monitoring system that include this characteristic configuration, but can also be realized as a tire air pressure monitoring method whose steps are these characteristic processes, or be realized as a control program for causing a computer to execute these steps. Also, the disclosure can be realized as a semiconductor integrated circuit that realizes part of, or the entirety of, the monitoring device and the tire air pressure monitoring system, or be realized as another system that includes the monitoring device and the tire air pressure monitoring system.

### Effect of Present Disclosure

With the present disclosure, it is possible to provide a monitoring device, a tire air pressure monitoring system, and a control program that can output a warning signal when a vehicle is stopped in a position in which bidirectional communication becomes impossible, in order to be able to monitor the tire air pressure before the vehicle starts moving again.

### BRIEF DESCRIPTION OF DRAWINGS

FIG. 1 is a conceptual diagram showing an example configuration of a tire air pressure monitoring system according to a first embodiment of the present disclosure.

FIG. 2 is a block diagram showing an example configuration of a monitoring device according to the first embodiment of the present disclosure.

FIG. 3 is a conceptual diagram showing an example of an identifier table.

FIG. 4 is a block diagram showing an example configuration of a detection device according to the first embodiment of the present disclosure.

FIG. 5 is a flowchart showing a processing procedure of the monitoring device according to the first embodiment.

FIG. 6 is a schematic diagram showing an air pressure notification mode at a time when the vehicle is moving.

FIG. 7 is a schematic diagram showing a warning notification mode at a time when the vehicle is stopped in a region in which communication is not possible.

FIG. 8 is a schematic diagram showing a communication state notification mode when the vehicle is moves after the warning.

FIG. 9 is a flowchart showing a processing procedure of the monitoring device according to a second embodiment.

FIG. 10 is a schematic diagram showing a communication state notification when communication is not possible before the vehicle starts moving.

### DETAILED DESCRIPTION OF PREFERRED EMBODIMENTS

First, embodiments of the present disclosure will be listed and described. Also, at least some of the embodiments described below may be combined as appropriate.

A monitoring device according to an aspect of the present disclosure transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal, and monitors the air pressure of the tire, the monitoring device comprising: an acquisition unit configured to acquire information related to movement or stoppage of the vehicle; a request signal transmission unit configured to wirelessly transmit the request signal to the detection device if it is determined that the vehicle is stopped based on the information acquired by the acquisition unit; an air pressure signal reception unit configured to receive the air pressure signal that is transmitted from the detection device in response to the request signal; and an output unit configured to, in a case where the request signal transmission unit transmitted the request signal, outputs a warning signal for giving a warning inside the vehicle, if the air pressure signal in response to the request signal is not received by the air pressure signal reception unit.

With this aspect, the monitoring device transmits the request signal to the detection device when the vehicle stops. If the detection device is in an incommunicable area, the request signal transmitted from the monitoring device does not reach the detection device and the air pressure signals are not transmitted if the monitoring device, despite having transmitted the request signal, does not receive the air pressure signal that should have been transmitted from the detection device that is the transmission destination of the request signal, then the monitoring device outputs a warning signal to give a warning that the vehicle should be moved. The warning signal is output to a display apparatus, an audio playback apparatus, or the like provided in the vehicle, for example, and the driver is thus warned. Accordingly, it is possible to direct the driver so as to ensure that the vehicle does not stop in a position in which bidirectional communication between the monitoring device and the detection device becomes impossible. Thus, after the vehicle stops, the monitoring device can detect the air pressure of the tires before the vehicle starts to move again.

The monitoring device, wherein the acquisition unit acquires information related to an operational state of an ignition switch, and the request signal transmission unit transmits the request signal to the detection device, if the ignition switch is switched from OFF to ON, and, if the request signal is transmitted by the request signal transmission unit, the output unit outputs a notification signal for giving a notification that air pressure monitoring will start after the vehicle starts moving, when the air pressure signal in response to the request signal is not received by the air pressure signal reception unit.

With this aspect, the monitoring device transmits the request signal to the detection device when the ignition switch is switched from OFF to ON. In other words, the monitoring device transmits the request signal when the vehicle is stopped and before the vehicle starts moving. If the detection device is in an incommunicable area, the request signal transmitted from the monitoring device does not reach the detection device and the air pressure signal is not transmitted from the detection device. However, once the vehicle starts to move and the tires rotate even slightly, it is possible that the detection device can exit the incommunicable area. Therefore, instead of the warning signal, the monitoring device outputs a notification signal giving a notification that the air pressure of the tire will start to be monitored after the vehicle starts moving. The notification signal is output to a display apparatus, an audio playback apparatus, or the like provided in the vehicle, for example, and the driver can be notified that the air pressure of the tire will start to be monitored after the vehicle starts moving.

The monitoring device, wherein if the ignition switch is switched from OFF to ON, after the notification signal is output, and it is determined that the vehicle has started to move based on the information acquired by the acquisition unit, the output unit outputs a malfunction warning signal for giving a notification that the detection device is malfunctioning, when the air pressure signal in response to the request signal is not received by the air pressure signal reception unit.

With this aspect, in a state in which the monitoring device and the detection device cannot perform bidirectional communication, the detection device transmits the request signal to the detection device when the vehicle has started to move. If the monitoring device, despite having transmitted the request signal, does not receive the air pressure signal that should have been transmitted from the detection device that is the transmission destination of the request signal, then the monitoring device determines that there is a possibility that the detection device is malfunctioning and outputs a malfunction warning signal. The malfunction warning signal is output to a display apparatus, an audio playback apparatus, or the like provided in the vehicle, for example, and the driver can be warned that there is a possibility that the detection device is malfunctioning.

A tire air pressure monitoring system according to an aspect of the present disclosure comprising: the monitoring device according to any one of claims 1 to 3; and a detection device that is provided in a tire of a vehicle and is configured to wirelessly transmit an air pressure signal obtained by detecting an air pressure of the tire, wherein the monitoring device receives the air pressure signal transmitted from the detection device and monitors the air pressure of the tire.

With this aspect, similar to aspect (1), when the vehicle stops in a state in which the detection device is in an incommunicable area, the monitoring device can output a warning signal with an output unit, and it is thus possible to direct the driver so as to ensure that the vehicle does not stop in a position in which bidirectional communication between the monitoring device and the detection device becomes impossible.

A control program according to an aspect of the present disclosure for causing a control unit of a monitoring device that transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal and monitors the air pressure of the tire to: acquire information related to movement or stoppage of the vehicle; wirelessly transmit the request signal to the detection device if it is determined that the vehicle is stopped based on the acquired information; receive the air pressure signal that is transmitted from the detection device in response to the request signal; and in a case where the monitoring device transmitted the request signal, output a warning signal for giving a warning inside of the vehicle, when the air pressure signal in response to the request signal is not received by the monitoring device.

With this aspect, similar to aspect (1), when the vehicle stops in a state in which the detection device is in an incommunicable area, the monitoring device can output a warning signal with an output unit, and it is thus possible to direct the driver so as to ensure that the vehicle does not stop in a position in which bidirectional communication between the monitoring device and the detection device becomes impossible.

Specific examples of a tire air pressure monitoring system according to an embodiment of the present disclosure will be described below with reference to the drawings. Note that the present disclosure is not limited to these examples, but rather is indicated by the scope of the claims, and all changes that come within the meaning and range of equivalence of the claims are intended to be embraced therein.

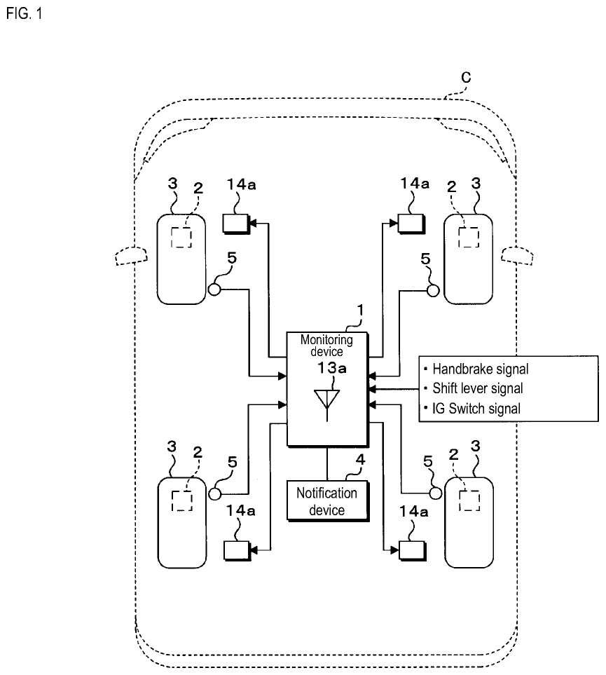

FIG. 1 is a conceptual diagram showing an example configuration of the tire air pressure monitoring system according to the first embodiment of the present disclosure. The tire air pressure monitoring system according to the first embodiment includes a monitoring device 1 that is provided in an appropriate position inside the body of a vehicle, detection devices 2 that are provided in each wheel of a plurality of tires 3 that are attached to a vehicle C, a notification device 4, and tire rotational position detection units 5. With the tire air pressure monitoring system of the first embodiment, the monitoring device 1 performs bidirectional wireless communication with the detection devices 2 to acquire air pressure information about the tires 3, and the notification device 4 gives a notification according to the acquired air pressure information.

The monitoring device 1 is connected to a plurality of LF transmission antennas 14a that correspond to the tires 3. The LF transmission antennas 14a are antennas for wirelessly transmitting 30 kHz to 300 kHz LF signals. Four LF transmission antennas 14a are provided, with one thereof provided on the front-right, the rear-right, the front-left, and the rear-left tire positions of the vehicle C, for example. The tire positions are positions in the wheel wells or the periphery thereof, and are positions at which the signals that are respectively transmitted from the LF transmission antennas 14a can be individually received by the detection devices 2 that are provided in the respective tires 3. The monitoring device 1 uses LF radio waves to transmit, from the LF transmission antennas 14a to the detection devices 2 provided on the tires 3, a request signal to request information about the air pressure of the tires.

If the detection devices 2 receive the request signal transmitted from the monitoring device 1, the detection devices 2 detect the air pressures of the tires 3 and use 300 MHz to 3 GHz UHF radio waves to transmit air pressure signals that include information about the detected air pressures to the monitoring device 1. The monitoring device 1 receives the air pressure signals that have been transmitted from the detection devices 2, and monitors the air pressures of the tires 3.

Note that LF and UHF radio waves are examples of radio wave bands that are used to perform wireless communication, but the present disclosure is not necessarily limited thereto.

The notification device 4 is connected to the monitoring device 1 via a communication line, and the monitoring device 1 outputs a signal indicating the acquired information about the tire air pressures to the notification device 4. The notification device 4 receives the signal that is output by the monitoring device 1 and gives a notification about the air pressures of the tires 3. If there is a tire 3 with an air pressure below a predetermined threshold, the monitoring device 1 outputs an abnormality notification signal to the notification device 4 in order to notify the driver about the tire air pressure abnormal.

Also, a handbrake signal, a shift lever signal, an ignition switch signal (IG switch signal in FIG. 1), and signals from the tire rotational position detection units 5 are input to the monitoring device 1 as information for detecting the that the vehicle is stopped. These signals will be described in detail later.

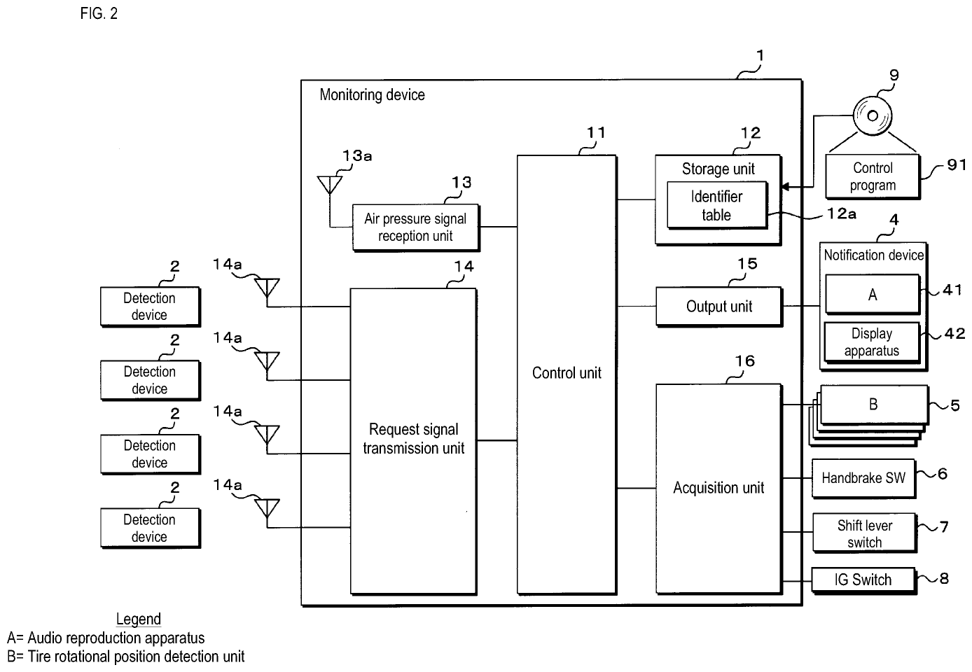

FIG. 2 is a block diagram showing an example configuration of the monitoring device 1 according to the first embodiment of the present disclosure. The monitoring device 1 includes a control unit 11 that controls the operation of the constituent units of the monitoring device 1. A storage unit 12, an air pressure signal reception unit 13, a request signal transmission unit 14, an output unit 15, and an acquisition unit 16 are connected to the control unit 11.

The control unit 11 is a microcomputer that has one or more CPUs (Central Processing Units), a multi-core CPU, a ROM (Read Only Memory), a RAM (Random Access Memory), an input-output interface, and/or the like. The CPU of the control unit 11 is connected via the input-output interface to the storage unit 12, the air pressure signal reception unit 13, the request signal transmission unit 14, the output unit 15, and the acquisition unit 16. The control unit 11 executes a control program 91, which will be described later, that is stored on the storage unit 12 to control the operation of the constituent units and execute processing for tire air pressure monitoring according to the first embodiment.

The storage unit 12 is a non-volatile memory such as an EEPROM (Electrically Erasable Programmable ROM) or a flash memory. The storage unit 12 stores the control program 91 for executing tire air pressure monitoring processing and processing such as detecting the communication state with the detection devices 2, and issuing warnings, by the control unit 11 controlling the operation of the constituent units of the monitoring device 1. Note that the control program 91 according to the first embodiment may also be stored on a recording medium 9 so as be readable by a computer. The storage unit 12 stores the control program 91 that is read out from the recording medium 9 by a readout device (not shown). The recording medium 9 may be an optical disc such as a CD (Compact Disc)-ROM, a DVD (Digital Versatile Disc)-ROM, or a BD (Blu-ray (registered trademark) Disc), a magnetic disc such as a flexible disk or a hard disk, a magnetic optical disk, or a semiconductor memory. Also, the control program 91 according to the first embodiment may be downloaded from an external computer (not shown) that is connected to a communication network (not shown), and stored in the storage unit 12.

The storage unit 12 also stores an identifier table 12a. The identifier table 12a will be described in detail later.

An RF reception antenna 13a is connected to the air pressure signal reception unit 13. The air pressure signal reception unit 13 receives, with the RF reception antenna 13a, signals that have been transmitted from the detection devices 2 with use of RF radio waves. The air pressure signal reception unit 13 is a circuit that demodulates the received signals and outputs the demodulated signals to the control unit 11. The UHF is used as the carrier wave, but the carrier wave is not limited to this frequency.

The request signal transmission unit 14 is a circuit that modulates the signal output from the control unit 11 to an LF signal and transmits the modulated signal from the plurality of LF transmission antennas 14a to the plurality of detection devices 2. Specifically, the request signal transmission unit 14, in accordance with the control of the control unit 11, sequentially transmits request signals requesting the transmission of the air pressure signals from the LF transmission antennas 14a. The LF is used as the carrier wave, but the carrier wave is not limited to this frequency.

The output unit 15 is an interface that outputs signals and the notification device 4 is connected thereto. The output unit 15, in accordance with the control of the control unit 11, outputs to the notification device 4 a signal indicating tire air pressure, an abnormality notification signal for issuing a notification that air pressure is abnormal, and various signals indicating information regarding the communication state between the monitoring device 1 and the detection devices 2. Note that the output unit 15 may also be a communication circuit that performs communication in accordance with a communication protocol such as CAN (Controller Area Network) or LIN (Local Interconnect Network).

The notification device 4 includes an audio reproduction apparatus 41 that receives a signal output from the output unit 15 and uses audio to give a notification regarding information about the air pressure of the tires 3 and information about the communication state between the monitoring device 1 and the detection devices 2, and a display apparatus 42 that uses images to give the aforementioned notifications. The audio reproduction apparatus 41 may be a warning speaker or a speaker of a car navigation system or an audio device. The display apparatus 42 may be a liquid crystal display, an organic EL display, a head-up display, a display unit provided in a meter of an instrument panel, or the like.

A plurality of tire rotational position detection units 5 that detect the rotational speed of the tires 3, a handbrake switch (see FIG. 2, handbrake switch SW) 6, a shift level switch 7, and an ignition switch (IG switch in FIG. 2) 8 are connected to the acquisition unit 16.

The tire rotational position detection units 5 are pulse encoders that are provided on the vehicle sides, and output one pulse signal whenever the tires 3 rotate to a predetermined angle. For this reason, if the tires 3 rotate once, a predetermined number of pulse signals are output from the tire rotational position detection units 5. The acquisition unit 16 can detect the rotational angle of the tires 3 and the speed of the vehicle by counting the number of pulse signals that have been output from the tire rotational position detection unit 5.

The side brake switch 6 is a switch that switches ON and OFF according to the position of the drive brake lever, and is also a switch that outputs a signal that indicates whether or not the side brake is engaged. The control unit 11 can detect the operational state of the side brake by acquiring a signal that is input to the acquisition unit 16 from the side brake switch 6. Note that the side brake is an example of a parking break, and may also be a foot-operated break.

The shift level switch 7 is a switch whose state switches according to the shift position, and outputs a signal according to the states. The control unit 11 can detect the position of the shift position by acquiring a signal that is input to the acquisition unit 16 from the shift level switch 7. The control unit 11 can detect at least whether or not the shift lever is in the parking position or in the neutral position.

The ignition switch 8 outputs an ignition switch signal according to the operational state thereof. The control unit 11 can detect the operational state of the ignition switch 8 by acquiring the ignition switch signal that is input from the ignition switch 8 to the acquisition unit 16.

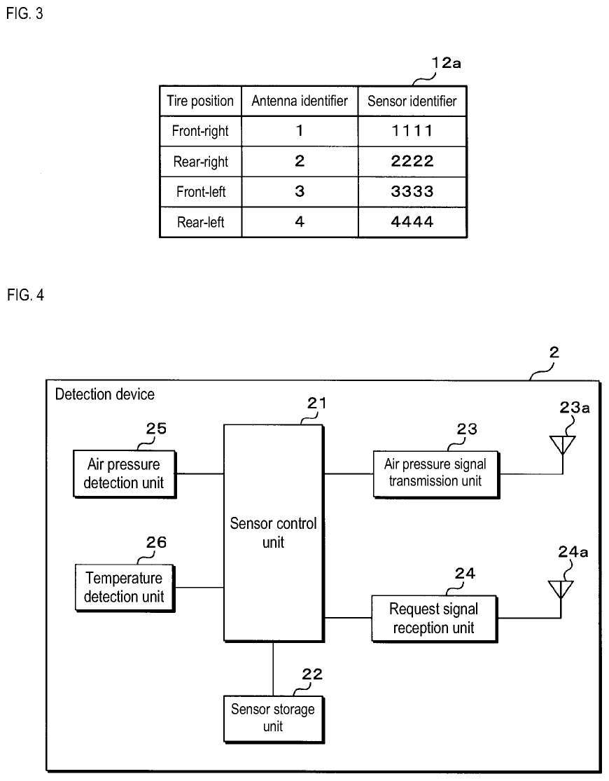

FIG. 3 is a conceptual diagram showing an example of the identifier table 12a. The identifier table 12a stores a plurality of tire positions, antenna identifiers for identifying the LF transmission antennas 14a that are arranged in the vicinity of the tire positions, and sensor identifiers of the detection devices 2 that are provided in the tires 3 at the tire positions in association with each other. Note that in the example illustrated in FIG. 3, the antenna identifiers ‘1’, ‘2’, ‘3’, and ‘4’ indicate the LF transmission antennas 14a that are respectively provided at the front-right, the rear-right, the front-left, and the rear-left tire positions. Also, the sensor identifiers ‘1111’, ‘2222’, ‘3333’, and ‘4444’ are respectively associated with the front-right, rear-right, front-left, and rear-left tire positions.

FIG. 4 is a block diagram showing an example configuration of the detection device 2 according to the first embodiment of the present disclosure. The detection device 2 includes a sensor control unit 21 that controls the operation of the constituent units of the detection device 2. The sensor control unit 21 is connected to a sensor storage unit 22, an air pressure signal transmission unit 23, a request signal reception unit 24, an air pressure detection unit 25, and a temperature detection unit 26.

The sensor control unit 21 is a microcomputer that has one or more CPUs, a multi-core CPU, a ROM, a RAM, an input-output interface, and/or the like. The CPU of the sensor control unit 21 is connected via the input-output interface to the sensor storage unit 22, the air pressure signal transmission unit 23, the request signal reception unit 24, the air pressure detection unit 25, and the temperature detection unit 26. The sensor control unit 21 reads out a mobile device control program that is stored on the sensor storage unit 22 and controls the units. The detection device 2 includes a battery (not shown) and operates using power from this battery.

The sensor storage unit 22 is a non-volatile memory. The sensor storage unit 22 stores the mobile device control program for the CPU of the sensor control unit 21 to perform processing related to the detection and transmission of the air pressure of the tire 3. Also, the sensor storage unit 22 stores a unique sensor identifier for identifying the detection device 2 from other detection devices 2.

The air pressure detection unit 25 includes a diaphragm, for example, and detects the air pressure of the tire 3 based on how much the diaphragm, which changes in size according to the magnitude of the pressure, deforms. The air pressure detection unit 25 outputs a signal indicating the detected air pressure of the tire 3 to the sensor control unit 21.

The temperature detection unit 26 includes elements whose electrical resistance changes depending on temperature, for example, and detects the temperature of the tire 3 based on the voltage between the elements, which changes according to changes in temperature. The temperature detection unit 26 outputs a signal indicating the detected temperature of the tire 3 to the sensor control unit 21.

An RF transmission antenna 23a is connected to the air pressure signal transmission unit 23. The air pressure signal transmission unit 23 modulates the air pressure signal that is generated by the sensor control unit 21 into a UFH signal and transmits the modulated air pressure signal with use of the RF transmission antenna 23a.

An LF reception antenna 24a is connected to the request signal reception unit 24. The request signal reception unit 24 uses the LF reception antenna 24a to receive various signals, such as request signals, that have been transmitted from the monitoring device 1 with use of LF radio waves, and outputs the received signals to the sensor control unit 21.

The sensor control unit 21 executes the mobile device control program to acquire, from the air pressure detection unit 25 and the temperature detection unit 26, signals that indicate the air pressure and temperature of the tire 3, generate an air pressure signal that includes air pressure and temperature information based on the aforementioned signals, as well as a unique sensor identifier of the detection device 2, and output the air pressure signal to the air pressure signal transmission unit 23.

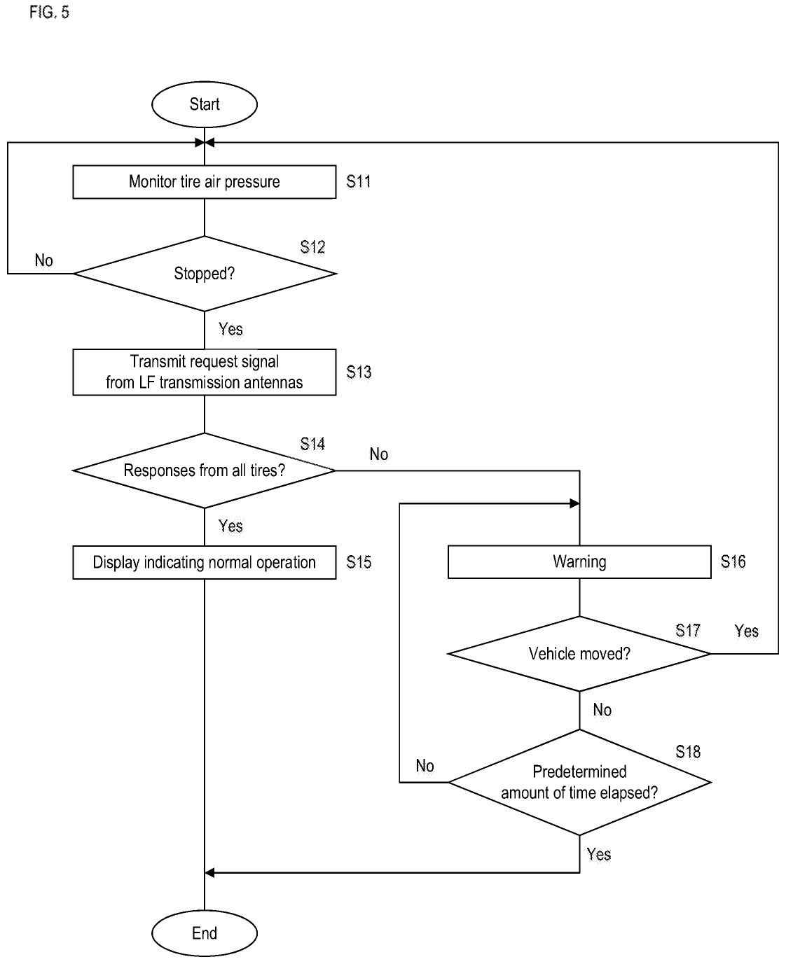

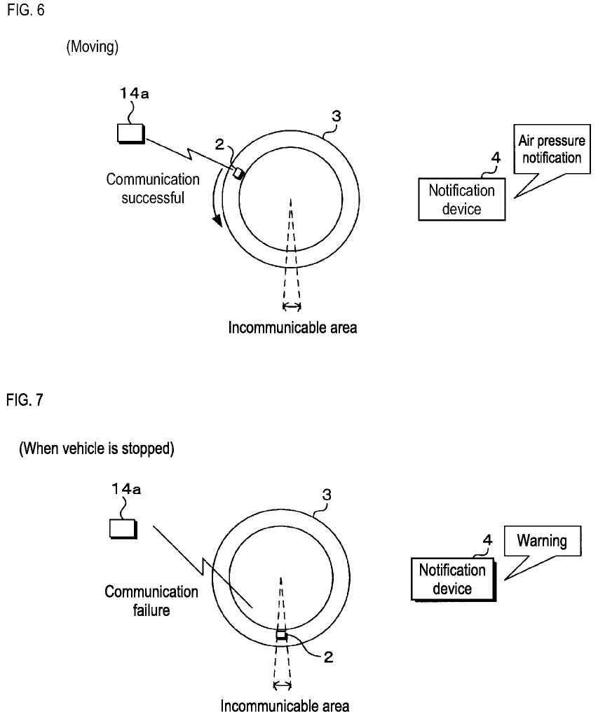

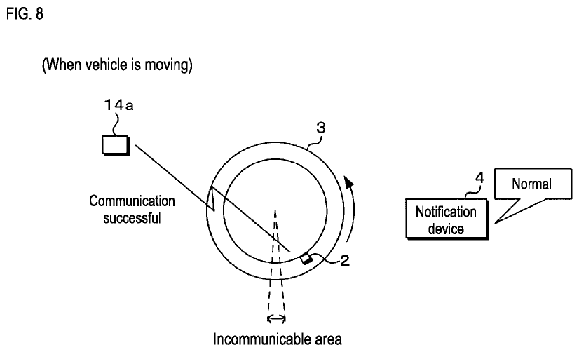

FIG. 5 is a flowchart showing the processing procedure of the monitoring device 1 according to the first embodiment, FIG. 6 is a schematic diagram showing an air pressure notification mode at a time when the vehicle is moving, FIG. 7 is a schematic diagram showing a warning notification mode when the vehicle enters a region in which communication is not possible when the vehicle is stopped, and FIG. 8 is a schematic diagram showing a communication state notification mode when the vehicle is moving after the warning. While the vehicle C is moving, the control unit 11 of the monitoring device 1 executes the following processing and monitors the air pressures of the tires 3.

The control unit 11 of the monitoring device 1 monitors the air pressures of the tires 3 (step S11). Specifically, the control unit 11 causes the request signal transmission unit 14 to transmit the request signals to the detection devices 2 provided in the front-right, the rear-right, the front-left, and the rear-left tires 3. If the detection devices 2 receive the request signal output from the monitoring device 1 with use the request signal reception unit 24, the detection devices 2 use the air pressure detection unit 25 and the temperature detection unit 26 to detect the air pressures and temperatures of the tires 3, and use the air pressure signal transmission unit 23 to transmit air pressure signals that include the detected air pressure and temperature, the sensor identifiers, and the like. The monitoring device 1 uses the air pressure signal reception unit 13 to receive the air pressure signals that are transmitted from the detection devices 2 and uses the output unit 15 to output the air pressure information that is included the received air pressure signal to the notification device 4. As shown in FIG. 6, the notification device 4 to which the air pressure information is input notifies the driver of the air pressures of the tires 3.

Next, the control unit 11 determines whether or not the vehicle C is stopped (step S12). Specifically, the control unit 11 uses the acquisition unit 16 to acquire signals that are output from the tire rotational position detection units 5, the handbrake switch 6, the shift level switch 7, and the ignition switch 8. Based on the aforementioned signals, the control unit 11 determines whether or not the vehicle C is stopped by determining whether or not the speed of the vehicle C is 0 km/h, the handbrake is engaged, the shift lever is in the parking position or the neutral position, and the ignition switch 8 is OFF.

Note that an example was described where the stopped state of the vehicle is detected by detecting the states of all of the speed, the side brake, the shift lever, and the ignition switch 8, but a configuration is also possible in which any one of, or an appropriate combination of the speed, handbrake, shift lever, and the ignition switch 8 are used to detect that the vehicle is stopped. Also, rather than by determining that the ignition switch 8 is OFF, a configuration is also possible in which it is detected that the vehicle is stopped by determining whether or not accessory power of the ignition switch 8 is OFF.

If it is determined that the vehicle C has not stopped (step S12: NO), that is, the vehicle C is moving or the engine is operating, the control unit 11 returns processing to step S11 and continues monitoring the tire air pressures. If it is determined that the vehicle C is stopped (step S12: YES), the control unit 11 causes the request signal transmission unit 14 to transmit a request signal requesting information about air pressure to be transmitted from the LF transmission antennas 14a(step S213).

Next, the control unit 11 determines whether or not there were responses from the detection devices 2 of all the tires 3 (step S14). In other words, the control unit 11 determines whether or not air pressure signals have been received from all of the detection devices 2. If it is determined that there were responses from all of the tires 3 (step S14: YES), the control unit 11 uses the output unit 15 to output a signal for indicating that the communication states of the monitoring device 1 and the detection devices 2 are normal to the notification device 4 (step S15), and ends processing. As shown in FIG. 8, the notification device 4 to which the aforementioned signals are input, performs display or audio output indicating that the monitoring device 1 is operating normally.

If it is determined that there is a detection device 2 that has not responded (step S14: NO), the control unit 11 uses the output unit 15 to output a warning signal indicating that there is an abnormality in the bidirectional communication of the monitoring device 1 and the detection devices 2 to the notification device 4, and that the vehicle C should be moved (step S16). As shown in FIG. 7, the notification device 4 to which the warning signal is input, notifies the driver with a warning that the vehicle C should be moved. Note that the content of the warning may be a warning that the vehicle C should be moved forwards or moved backwards.

Next, the control unit 11 uses the acquisition unit 16 to acquire a signal output from the tire rotational position detection unit 5 and determines whether or not the vehicle C has moved (step S17). If it is determined that the vehicle C has moved (step S17: YES), the control unit 11 returns processing to step S11, and the monitoring device 1 determines whether or not the state of communication with the detection devices 2 has improved by executing the processing of steps S11 to S17. If the communication state of the monitoring device 1 and the detection devices 2 is normal due to movement of the vehicle C, the control unit 11, through the processing of step S15, uses the output unit 15 to output a signal indicating that the communication state of the monitoring device 1 and the detection devices 2 are normal to the notification device 4 (step S15), and ends processing. As shown in FIG. 8, the notification device 4 to which the aforementioned signal is input performs display or audio output indicating that the monitoring device 1 is operating normally.

If it is determined that the vehicle C has not moved (step S17: NO), the control unit 11 determines whether or not a predetermined amount of time has elapsed since the vehicle stopped (step S18). Note that the point in time from which the predetermined amount of time timed is not limited to the time that the vehicle stopped, and may be the time that the request signal is transmitted or may be the time of the determination in step S14.

If it is determined that the predetermined amount of time has not elapsed (step S18: NO), the control unit 11 returns processing to step S16 and continues to give the warning. If it is determined that the predetermined amount of time has passes (step S18: YES), the control unit 11 ends processing.

With the tire air pressure monitoring system according to the first embodiment configured in such a way, if the vehicle C stops in a position in which bidirectional communication between the monitoring device 1 and the detection devices 2 becomes impossible, the monitoring device 1 outputs a warning signal to the notification device 4 and gives a notification indicating that communication is not possible. In other words, the monitoring device 1 can direct the vehicle C so as to ensure that the vehicle C does not stop in a position in which bidirectional communication between the monitoring device 1 and the detection devices 2 becomes impossible. Accordingly, after the vehicle is stopped, the monitoring device 1 can detect the air pressures of the tires 3 and can notify the driver about the state of the tire air pressure, before the vehicle starts moving again.

### Second Embodiment

The tire air pressure monitoring system, monitoring device 1, and control program 91 according a second embodiment detect the communication state of the monitoring device 1 and the detection devices 2 when the vehicle C is stopped and before the vehicle starts moving due to the ignition switch 8 being switched from OFF to ON, and a necessary notification is performed. The tire air pressure monitoring system, monitoring device 1, and control program 91 according to the second embodiment are different from that of the first embodiment in terms of the processing procedure when the vehicle is stopped before starting to move, and the following descriptions focuses mainly on the differences. Other configurations and effects are similar to those of the first embodiment and thus the same places shall be denoted with the same reference numerals and detailed descriptions thereof shall be omitted.

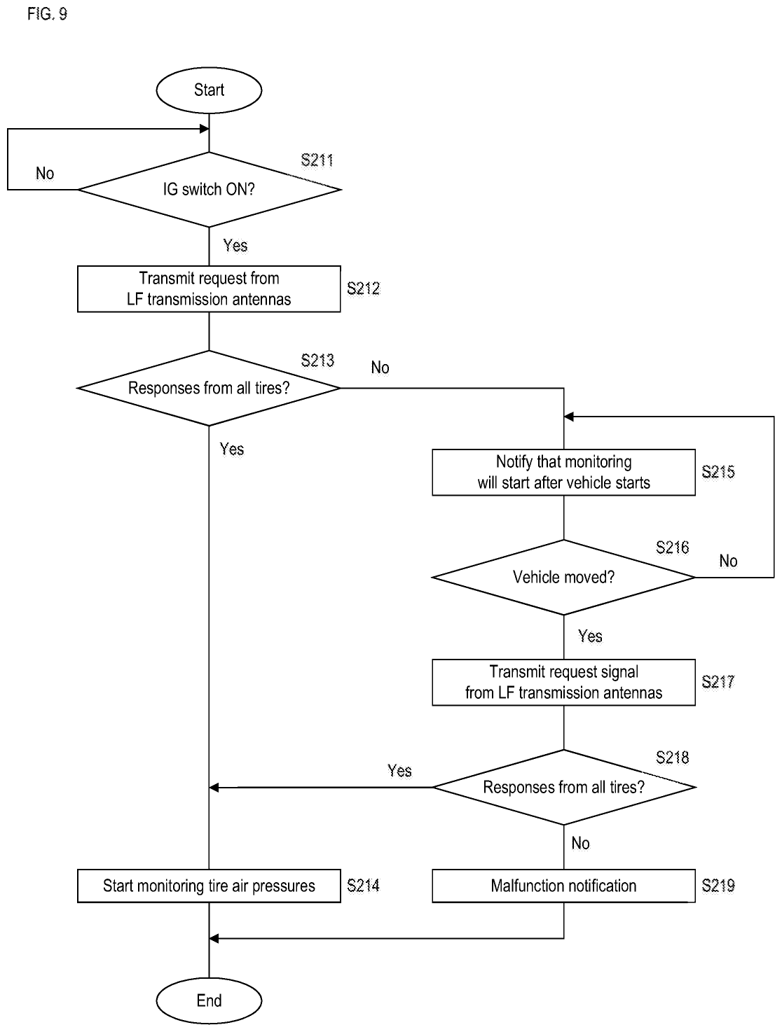

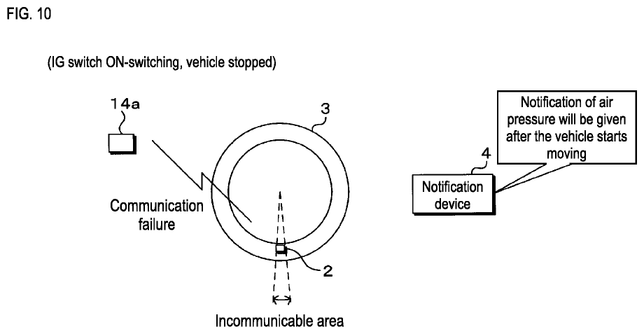

FIG. 9 is a flowchart showing a processing procedure of the monitoring device 1 according to the second embodiment and FIG. 10 is a schematic diagram showing the communication state notification mode when communication before the vehicle starts moving is impossible. The control unit 11 of the monitoring device 1 acquires an ignition switch signal that is input to the acquisition unit 16, and determines whether or not the ignition switch 8 has switched from OFF to ON (step S211). If it is determined that the ignition switch 8 is OFF (step S211: NO), the control unit 11 returns processing to step S211 and continues the monitoring of the operational state of the ignition switch 8. If it is determined that the ignition switch 8 has switched from OFF to ON (step S211: YES), the control unit 11 causes the transmission unit 14 to transmit a request signal requesting information about air pressure from the LF transmission antennas 14a (step S212).

Next, the control unit 11 determines whether or not there were responses from the detection devices 2 of all the tires 3 (step S213). If it is determined that there were responses from all of the tires 3 (step S213: YES), the control unit 11 starts the monitoring of the tire air pressure (step S214). Thereafter, the monitoring device 1 executes the processing described in the first embodiment.

If it is determined that there is a detection device 2 that has not responded (step S213: NO), the control unit 11 uses the output unit 15 to output a signal indicating that the monitoring of the air pressure of the tires will start after the vehicle starts moving to the notification device 4. As shown in FIG. 10, the notification device 4 displays text such as “A notification of air pressure will be given after the vehicle starts moving”.

Next, the control unit 11 uses the acquisition unit 16 to acquire the signals that are output from the tire rotational position detection units 5, and determines whether or not the vehicle C has moved (step S216). If it is determined that the vehicle has not moved (step S216: NO), the control unit 11 returns processing to step S215. If it is determined that the vehicle C has moved (step S216: YES), the control unit 11, again, causes the request signal transmission unit 14 to transmit a request signal requesting information about air pressure from the LF transmission antennas 14a (step S217).

Next, the control unit 11 determines whether or not there were responses from the detection devices 2 of all of the tires 3 (step S218). If it is determined that there was a response from all of the tires 3 (step S218: YES), the control unit 11 starts the monitoring of the air pressure of the tires (step S214). If it is determined that there is a detection device 2 that has not responded despite the vehicle C having started to move (step S218: NO), the control unit 11 uses the output unit 15 to output a malfunction warning signal to the notification device 4 indicating that there is a malfunctioning detection device 2. The notification device 4 notifies the driver that there is a possibility that a specific detection device 2 is malfunctioning.

In the tire air pressure monitoring system configured in this way, if the ignition switch 8 is switched from OFF to ON, the monitoring device 1 confirms the state of communication with the detection devices 2 of the tires 3. Supposing that even if there is a detection device 2 that does not respond with an air pressure signal, once the vehicle C starts moving and the tires 3 rotate even slightly, it is possible that the detection device 2 can exit the incommunicable area, and therefore the monitoring device 1 gives a notification that the monitoring of the air pressure will start after the vehicle starts moving, instead of issuing a warning. Then, if communication of the monitoring device 1 and the detection devices 2 is not performed normally even after the vehicle C starts moving, there is a high possibility that there is a detection device 2 that is malfunctioning. In this case, the monitoring device 1 outputs a malfunction warning signal to the notification device 4 and gives a notification that there is a possibility that there is a detection device 2 that is malfunctioning.

As described above, with the monitoring device 1, even if communication with the detection devices 2 is abnormal, it is possible to avoid giving a warning that may unsettle the driver and to notify the driver that the monitoring of the air pressure will start after the vehicle starts moving.

Also, if there are no abnormalities in the detection devices 2, it is possible to immediately start the monitoring of the air pressures of the tires and give a notification about the state of the air pressure of the tires 3, after the vehicle starts moving.

Furthermore, if there is still an abnormality in the communication of the monitoring device 1 and the detection devices 2 after the vehicle has started to move, the monitoring device 1 can give a notification that there is a possibility that there is an abnormality in a detection device 2.

1. A monitoring device that transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal, and monitors the air pressure of the tire, the monitoring device comprising:
an acquisition unit configured to acquire information related to movement or stoppage of the vehicle;
a request signal transmission unit configured to wirelessly transmit the request signal to the detection device if it is determined that the vehicle is stopped based on the information acquired by the acquisition unit;
an air pressure signal reception unit configured to receive the air pressure signal that is transmitted from the detection device in response to the request signal; and
an output unit configured to, in a case where the request signal transmission unit transmitted the request signal, outputs a warning signal for giving a warning inside the vehicle, if the air pressure signal in response to the request signal is not received by the air pressure signal reception unit.

2. The monitoring device according to claim 1, wherein
the acquisition unit acquires information related to an operational state of an ignition switch, and
the request signal transmission unit transmits the request signal to the detection device, if the ignition switch is switched from OFF to ON, and, if the request signal is transmitted by the request signal transmission unit, the output unit outputs a notification signal for giving a notification that air pressure monitoring will start after the vehicle starts moving, when the air pressure signal in response to the request signal is not received by the air pressure signal reception unit.

3. The monitoring device according to claim 2, wherein
if the ignition switch is switched from OFF to ON, after the notification signal is output, and it is determined that the vehicle has started to move based on the information acquired by the acquisition unit, the output unit outputs a malfunction warning signal for giving a notification that the detection device is malfunctioning, when the air pressure signal in response to the request signal is not received by the air pressure signal reception unit.

4. A tire air pressure monitoring system comprising:
the monitoring device according to claim 1; and
a detection device that is provided in a tire of a vehicle and is configured to wirelessly transmit an air pressure signal obtained by detecting an air pressure of the tire, wherein
the monitoring device receives the air pressure signal transmitted from the detection device and monitors the air pressure of the tire.

5. A control program for causing a control unit of a monitoring device that transmits a request signal for requesting air pressure information to a detection device that is provided in a tire of a vehicle and wirelessly transmits an air pressure signal obtained by detecting an air pressure of the tire, receives the air pressure signal that is transmitted from the detection device in response to the request signal and monitors the air pressure of the tire to:
acquire information related to movement or stoppage of the vehicle;
wirelessly transmit the request signal to the detection device if it is determined that the vehicle is stopped based on the acquired information;
receive the air pressure signal that is transmitted from the detection device in response to the request signal; and
in a case where the monitoring device transmitted the request signal, output a warning signal for giving a warning inside of the vehicle, when the air pressure signal in response to the request signal is not received by the monitoring device.
